(19) United States
(12) Patent Application Publication
(10) Pub. No.: US 2020/0209125 A1
(43) Pub. Date: Jul. 2, 2020

(54) FRACTIONATION GAS SAMPLING DEVICE

(71) Applicant: KALOON ANALYTICAL INSTRUMENTS (BEIJING) CO., LTD., Beijing (CN)

(72) Inventors: Huitao REN, Beijing (CN); Deli XING, Beijing (CN)

(21) Appl. No.: 16/509,084

(22) Filed: Jul. 11, 2019

(30) Foreign Application Priority Data
Dec. 29, 2018 (CN) 201822249573.4

(51) Int. Cl. G01N 1/44; G01N 1/10; G01N 1/22; C10B 33/00

(52) U.S. Cl. CPC G01N 1/44; G01N 1/10; G01N 1/2247; G01N 2001/227; C10B 33/006; G01N 2001/1018; G01N 1/2294

(57) ABSTRACT

The present application discloses a gas sampling device, in particular, a fractionation gas sampling device comprising a heat exchanger, and the heat exchanger comprises one or more groups of tubes, wherein, a guide plate is disposed in the tubes. The fractionation gas sampling device further comprises a coke cleaning mechanism having a decoking head, and the decoking head has a circular arc guide. The fractionation gas sampling device has a large heat exchange area, a high heat exchange efficiency, and overcomes the surface tension between liquids so as to avoid generating liquid columns; moreover, by combining with the coke cleaning mechanism, the fractionation gas sampling device not only achieves excellent technical effects relevant to decoking, but also effectively prevents from a blocking phenomenon of the decoking head, thereby realizing an automatic cleaning.

### TECHNICAL FIELD

The present application relates to a sampling device, in particular, to a fractionation gas sampling device.

### BACKGROUND OF THE INVENTION

Conventional fractionation gas sampling devices are always used for sampling gas in a gas pipeline or device, and then introducing the sampled gas into the sampling pipe before analyzing and detecting those gases in the sampling pipe.

The existing fractionation gas sampling devices generally adopt a heat exchange unit or heat exchanger, but there is also a need to make improvements of the gas sampling devices due to some shortcomings existed in the prior art as below: the area of the heat exchanger is small, the liquid columns generate easily in the tube by the cooling liquids, and the heat exchange efficiency is relatively low; a decoking head is easily clamped and blocked when the decoking head moves in a reciprocating mode as a result of the low concentricity of the decoking head and the coking pipe; and the fault rate is always high due to the facts that there is no steam purging or the inner surface of the pipeline cannot be cleaned thoroughly in time, thereby causing the required maintenance frequency is very high.

### SUMMARY

In view of those above defects or shortcomings in the prior art, the present application provides a fractionation gas sampling device, which has a larger heat exchange area and a high heat exchange efficiency, moreover, there is no liquid columns generated in the tubes thereof, and correspondingly a coke cleaning mechanism is not prone to being clamped or blocked.

In one aspect, the present application provides a fractional gas sampling device comprising a heat exchanger, wherein the heat exchanger comprises one or more groups of tubes, and a guide plate is disposed in each tube.

In further, each group of tubes comprises a plurality of a first pipes, and a guide plate is configured in each first pipe.

The guide plate is spiral, runs through the first pipe, and contacts with the inner wall of the first pipe.

There is a guide plate configured in each first pipe.

All the guide plates are respectively and independently configured in a spiral shape along the inner wall of the first pipe.

One end of the tubes is connected to the inlet of the gas samples, and the other end of the tubes is connected to an outlet of the gas samples. In further, one end of the tubes is connected to the inlet of the gas samples via pipe connectors.

In another aspect, the present application provides a fractionation gas sampling device, the fractionation gas sampling device also comprises a coke cleaning mechanism optionally, wherein, the coke cleaning mechanism has a decoking head with a circular arc guide at its top.

The coke cleaning mechanism also includes a rod and a cylinder, wherein, one end of the rod is fixedly connected to the decoking head so as to make the decoking head move back and forth in the pipe through which the gas samples flow; the other end of the rod is fixedly connected to the cylinder. More specifically, during a sampling process, the gas samples flow successively through a second pipe, pipe connectors and a first pipe, and the decoking head preferably moves back and forth in the second pipe for carrying out decoking process.

Alternatively, the coke cleaning mechanism may be separately configured as a coke cleaning mechanical mechanism. Preset the starting time and running time of the decoking process according to the coking conditions in the pipes, and then select the starting point and the running pipes.

The decoking head has two or more than two flaky cutting tools arranged in a circular arc. Wherein, the cutting tool may be selected from a circular blade, a long blade, an arc blade, a tooth-shaped blade, a trapezoidal blade, a corrugated blade, a serrated blade, a disc blade, an irregular blade or any one of the combinations thereof.

In the fractionation gas sampling device, the tube heat exchanger also has an entrance. The entrance and the tube are connected. Wherein, by utilizing pipe connectors, the entrance is connected to the first pipe of the tube.

In further, the entrance is connected to the top of the first pipe. More specifically, the entrance is also connected to the outlet of gas samples.

Preferably, each group of the tubes includes 7-9 pipes.

Preferably, the diameter of the first pipe is 10-12.7 mm.

The diameter of the second pipe is larger than that of the first pipe.

### Advantageous Effects

The fractionation gas sampling device according to the present application comprises at least one group of tubes, and a guide plate is disposed within each group of tubes, thereby the fractionation gas sampling device has a larger heat exchange area, overcomes the surface tension between liquids by the guide plates, ensures the liquids generate no liquid columns in the tubes thereof, and increases the heat exchange efficiency.

Moreover, by combining with a coke cleaning mechanism that has a decoking head in a circular arc guide, the fractionation gas sampling device not only achieves excellent technical effects relevant to decoking, but also effectively prevents from a clamping and blocking phenomenon of the decoking head, thereby realizing an automatic cleaning of coke in a much longer period.

### BRIEF DESCRIPTION OF THE DRAWINGS

Other technical features, purposes and advantages of the present application will become more apparent by reading the detailed descriptions of the non-restrictive embodiments and referring to the attached drawings as below:

FIG. 1 is a structural schematic diagram of the fractionation gas sampling device according to one embodiment of the present application;

FIG. 2 is a structural schematic diagram of the tubes according to one embodiment of the present application;

FIG. 3 is a sectional view of the tubes according to one embodiment of the present application;

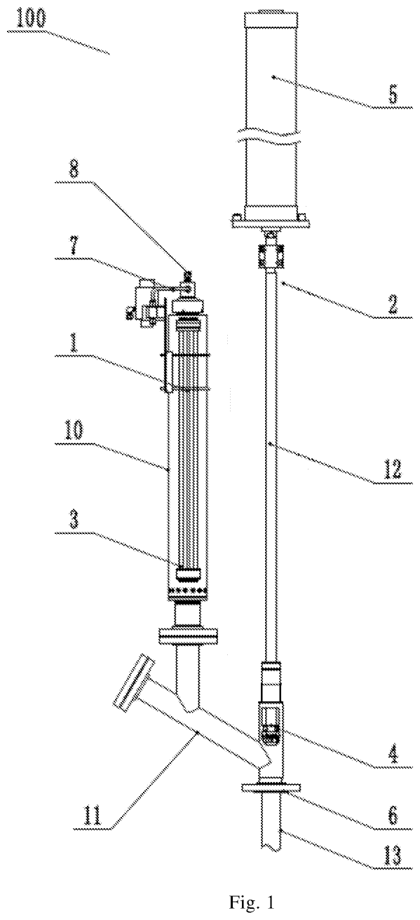

In FIGS. 1-3, the correspondence between reference numbers and the components is as follows: 100, the fractionation type gas sampling device; 1, a heat exchanger; 2, a coke cleaning mechanism; 3, the first pipe; 4, the decoking head; 5, cylinder; 6, inlet; 7, outlet; 8, entrance; 9, guide plate; 10, heat exchanger shell; 11, pipe connectors; 12, rod; 13, the second pipe.

### DETAILED DESCRIPTION OF THE EMBODIMENTS

The present application shall be further described in details in combination with the attached drawings and specific embodiments. It should be understood that, the specific embodiments described herein are used only to explain the relevant embodiments of the invention, but is not intended to limit the present invention. It should also be noted that, for ease of description, only some parts related to the present invention are shown in the attached drawings.

It should be noted that, without conflicts, in the present application the characteristics or features of the embodiments and the specific examples may be used adaptably either alone or in combination with each other. The present application shall be illustrated in details by referring to the attached drawings and embodiments.

In one embodiment, the present application provides a fractional gas sampling device comprising a heat exchanger, wherein the heat exchanger comprises one or more groups of tubes, a guide plate is disposed in each tube.

In further, each group of tubes comprises a plurality of a first pipes, and the guide plate is configured in each first pipe. The guide plate is spiral, and runs through the first pipe, and contacts with the inner wall of the first pipe.

There is a guide plate configured in each first pipe. The guide plate has a width depending on the inner radius of the first pipe. All the guide plates are respectively and independently configured in a spiral shape along the inner wall of the first pipe in which the guide plate may be configured in parallel or crossways.

One end of the first pipes in the tubes is connected to the inlet of the gas samples, and the other end of the tubes is connected to an outlet of the gas samples. In further, one end of the tubes is connected to the inlet of the gas samples via pipe connectors.

In another embodiment, the present application provides a fractionation gas sampling device, the fractionation gas sampling device also comprises a coke cleaning mechanism, wherein, the coke cleaning mechanism has a decoking head with a circular arc guide at its top.

The coke cleaning mechanism also includes a rod and a cylinder, wherein, one end of the rod is fixedly connected to the decoking head so as to make the decoking head move back and forth in the pipe through which the gas samples flow; the other end of the rod is fixedly connected to the cylinder. More specifically, during the sampling process, the gas samples flow successively through a second pipe, pipe connectors and a first pipe, and the decoking head preferably moves back and forth in the second pipe for carrying out decoking process.

The starting or running of the coke cleaning mechanism can be controlled according to the properties of the sample gas or the test conditions and the like. It can also be controlled by a control system, for example, a numerical control system, or a transmission mechanism assisted manually such as a control valve of cylinder.

Alternatively, the coke cleaning mechanism may be separately configured as a coke cleaning mechanical mechanism. Specify the starting time and running time of the decoking process according to the coking conditions in the pipes, and then select the starting point and the running pipes.

The decoking head has two or more flaky cutting tools arranged in a circular arc. Wherein, the cutting tool may be selected from a circular blade, a long blade, an arc blade, a tooth-shaped blade, a trapezoidal blade, a corrugated blade, a serrated blade, a disc blade, an irregular blade or any one of the combinations thereof.

In the fractionation gas sampling device, the tube heat exchanger also has an entrance. The entrance and the tube are connected with each other. Wherein, by utilizing pipe connectors, the entrance is also connected to the first pipe of the tubes.

In further, the entrance is connected to the top of the first pipe. More specifically, the entrance is also connected to the outlet of gas samples.

Preferably, each group of the tubes includes 7-9 pipes.

Preferably, the diameter of the first pipe is 10-12.7 mm.

The diameter of the second pipe is often larger than that of the first pipe.

FIG. 1 is a structural schematic diagram of the fractionation gas sampling device according to one embodiment of the present application. As shown in FIG. 1, the fractional gas sampling device 100 comprises a heat exchanger 1, the heat exchanger 1 includes a shell 10 and a group of tubes in the shell 10, each of the first pipe 3 in the tubes is used for pumping in gas samples, thereby the gas samples flowing through the first pipes; a guide plate 9 is disposed in the first pipe 3 of the tubes, meanwhile, the external area of each group of tubes is used for pumping the cooling medium; an inlet 6 for the gas samples is connected to one end of the first tubes 3, so that the gas samples enter into and then pass through the first pipe 3, and the gas sample outlet 7 is at the other end.

In the above embodiment, the fractionating gas sampling device also comprises a coke cleaning mechanism 2, which includes a decoking head 4 having a circular arc guide, a cylinder 5 and a rod 12, wherein, cylinder 5 may be selectively placed in the shell 10 or not; One end of the rod 12 is fixedly connected to cylinder 5 and the other end is connected to the decoking head 4, thus allowing the decoking head 4 to move back and forth in the pipe through which gas samples flow (for example, in the second pipe 13 or part of the second pipe 13). The decoking head 4 has two or more cutting tools arranged in a circular arc, such as cutting edges.

Specifically, the decoking head 4 is located inside of the inlet 6 of gas samples. It can enter into the second pipe 13 and then moves back and forth in the second pipe 13 so as to remove coke and the like from the pipe wall.

The fractionating gas sampling apparatus also comprises an inlet 8 from which a steam fluid is fed into the pipe for purging the dirty in the pipe. The inlet 8 may be configured at the top of the tubes, and the inlet 8 may be connected to the tubes. Specifically, the inlet 8 can be connected to the first pipe 3 via the pipe connectors. Moreover, the inlet 8 can also be connected to the outlet 7 of gas samples.

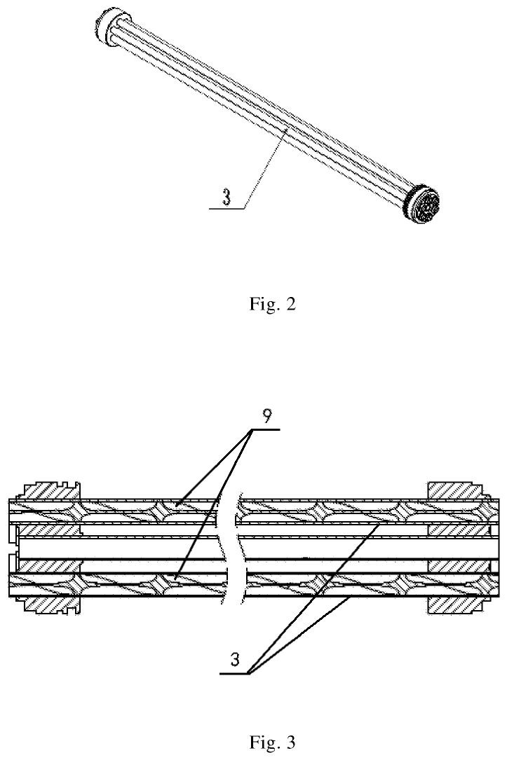

FIG. 2 is a structural schematic diagram of the tubes according to one embodiment of the present application. It can be seen clearly that each group of tubes includes a plurality of the first pipes 3.

The present application utilizes at least one group of tubes. Compared with the existing sampling devices, in the present application the heat exchanger increases the heat exchange area thereof, and improves the heat exchange efficiency. The cooling medium herein may use a coolant (e.g. water or oil) or gas (e.g. colded air or other colded gas).

A coke cleaning mechanism provided by the present application has a decoking head with a circular arc guide at its top. The decoking head has two or more than two cutting edges arranged in a circular arc. The cutting edge may be a chamfer edge. It achieves better technical effects relevant to decoking, but also effectively prevents from the decoking head being clamped and blocked. And it increases the heat exchange efficiency by use of pumping the flows (for example, high-pressure gas flow, or steam flow) and sweeping the dirty on the inner surface of the first pipe.

The inlet is located at the lower end of the tube heat exchanger, from which the gas samples may be pumped in the device. The outlet of the gas samples and the entrance of the cleaning gas are located at the top of the tube heat exchanger. This structure is helpful for the placement of the equipment and the connection of the pipes. The inlet is located at the lower end of the coke cleaning mechanism and connected to the first pipe of the tube heat exchanger.

FIG. 3 is a sectional view of the tubes according to one embodiment of the present application. Based on the above embodiments, FIG. 3 shows that a guide plate 9 is configured by inserting in the first pipe 3 of the groups of tubes. And the guide plate 9 is configured in each first pipe 3. The guide plate is spiral, and extends longitudinally along the first pipe.

In combination with FIGS. 1-3, it can be understood that, in the present application, there is a guide plate configured in each first pipe of all the groups of tubes. The condensed fluid generated between the guide plate and the inner wall of the tubes shall return to the pipe, and thus, it may ensure the fluid return smoothly, pass through the pipe connectors 11, the second pipe 13 and to the collection point of gas samples, or to the recycled pipe or cavity after passing through the pipe connectors 11, thereby preventing the condensed fluid from being entrained into the gas samples when sampling gas.

In this embodiment, each group of tubes includes 7-9 the first pipes.

Preferably, the diameter of the first pipe is 10-12.7 mm.

The tube heat exchanger in the present application further significantly enlarges the heat exchange area and increases the heat exchange efficiency by providing a plurality of the first pipes.

In this embodiment, the cutting tool on decoking head 4 may also be a chamfered edge.

The decoking head in the present application is constructed into a circular arc shape as a whole, which can avoid a stuck phenomenon of the decoking head caused by protrusions at the pipe surface, thereby achieving excellent coke cleaning effects. Common protrusions formed on the surface of pipes include protrusions caused by welding process or partially-open valve, or coke deposition of air inlet pipes and the surface thereof. The circular arc decoking head plays guide and correction roles, and it makes those partially-open valves open entirely or moves through the welding protrusions thereby preventing the blade of the decoking head from being damaged. In addition, by using this circular arc decoking head, the decoking operation and recycling operation is smoother. Considering the above features, the fractionation gas sampling device of the present application can be operated for a long period. When in use, the device shall be installed above the gas pipes or the device required sampling. Gases at a high temperature rise from the bottom of the device into the tubes of the tube type heat exchanger. After exchanging heat with the cooling medium outside the tubes, part of the medium with high condensation temperature in those high temperature gases shall be condensed at first and return to a withdrawing tube. When the components having an easy coke formation among the high-temperature gases, which are more likely to become solid or viscous liquid phases, adhere to the sampling tube, they can be removed from the wall of the pipes by the coke cleaning mechanism, and then further removed to the withdrawing pipes. In order to clean up those substances easily adhered to the inner wall, it may take use of steam purging way to clean the inner wall of pipes in the tubes, thereby removing the scaling substances of the surface and improving the heat exchange efficiency.

The above description only provides some preferred embodiments, and “a” or “an” used in the mechanism or device not only refers to a singular, but also comprises the plural or multiple meanings thereof. The protection scope of the present application comprises any combination of the above technical features, but is not limited to this. Meanwhile, in the case that does not divorce from the inventive concept of the present application, it should cover any combination of the above technical features, identical technical features, and other technical features modified or amended appropriately, for example, a technical solution formed by replacing the above features with the technical features with similar functions disclosed in the present application (but not limited to this).

1. A fractional gas sampling device, wherein, the fractional gas sampling device (100) comprises a heat exchanger (1) having one or more groups of tubes, and a guide plate (9) is disposed in each of the tubes.

2. The fractional gas sampling device of claim 1, wherein, each group of tubes comprises a plurality of a first pipes (3), and the guide plate (9) is configured in each first pipe (3).

3. The fractional gas sampling device of claim 1, wherein, one end of the tubes is connected to the inlet (6) of the gas samples, and the other end of the tubes is connected to an outlet (7) of the gas samples.

4. The fractional gas sampling device of claim 1, wherein, the fractionation gas sampling device also comprises a coke cleaning mechanism (2), wherein, the coke cleaning mechanism (2) has a decoking head (4) with a circular arc guide at its top.

5. The fractional gas sampling device of claim 4, wherein, the coke cleaning mechanism (2) also includes a rod (12) and a cylinder (5), wherein, one end of the rod (12) is fixedly connected to the decoking head (4) so as to make the decoking head (4) move back and forth in the pipe through which the gas samples flow, and the other end of the rod (12) is fixedly connected to the cylinder (5).

6. The fractional gas sampling device of claim 1, wherein, the fractional gas sampling device also has an entrance (8), and the entrance (8) is connected to the first pipe (3) of the tubes.

7. The fractional gas sampling device of claim 1, wherein, each group of the tubes includes 7-9 first pipes.

8. The fractional gas sampling device of claim 5, the diameter of the first pipe (3) is 10-12.7 mm.
